(19) United States
(12) Patent Application Publication
(10) Pub. No.: US 2013/0202121 A1
(43) Pub. Date: Aug. 8, 2013

(54) Method and System

(71) Applicants: Archiveades Georgiou, Essex (GB); Antony Zenonos, Enfield (GB)

(72) Inventors: Archiveades Georgiou, Essex (GB); Antony Zenonos, Enfield (GB)

(21) Appl. No.: 13/636,953

(22) PCT Filed: Mar. 25, 2011
(86) PCT No.: PCT/GB2011/000430

§ 371 Date: Apr. 2, 2013

(30) Foreign Application Priority Data
Mar. 25, 2010 (GB) 1005026.8

(51) Int. Cl. H04R 29/00

(52) U.S. Cl. CPC H04R 29/00
USPC 381/56

(57) ABSTRACT

A method of warning and/or reduction of risk of ear damage of a hearer by excessive exposure to relatively high volume and/or frequency of sound, wherein a non-audio input representative of desired sound and/or ambient sound is employed to warn of said risk and/or said risk is automatically reduced.

This invention relates to a method of and system for warning and/or reduction of risk of ear damage.

For well over a century, the risk of permanent damage to the hearing by exposure to excessive sound has been well known. More recently, it has been understood that such damage can be caused by relatively long exposure to sound that is still reasonably bearable.

In a scenario in which the hearer has no control over the sound heard, various regulatory authorities have established standards for governing the time during which sounds at particular sound levels are permissible, as well as broad spectrum sound levels. Examples of this scenario are disclosed in EP-A-529,158 and GB-A-2,430,319.

EP-A-529,158 discloses a system for controlling sound dosage, wherein microphones sample the sound output from speakers of sound amplification apparatus at, e.g., a pop concert site. Resulting time domain analog signals undergo a Fast Fourier Transform which yields frequency domain signals representative of the intensities of the frequency bands which compose the sound. The intensities or levels of each band are compared to stored permissible level limits for each frequency band. Attenuators respond to signals indicative of band levels being exceeded by respectively attenuating the frequency bands to which they are tuned so the speaker output does not contain frequencies which exceed permissible limits. The time weighted permissible averages for each frequency are also integrated to provide for production of signals representative of the cumulative sound dosage. When total dosage is trending toward exceeding permissible limits for the time during which the listeners are expected to be listening, the cumulative dose signals operate another attenuator to cause the volume emitted by the speaker to drop to a permissible level.

A similar system is disclosed in GB-A-2,430,319 for the control of audio output from loudspeakers at public concerts and the prevention of hearing damage to the audience, wherein, again, microphones sample the sound level heard by the audience. The audio signals fed back from the microphones are sampled and transformed using a Fourier transform algorithm to produce a signal representative of the amplitude of components of frequencies of the audio signal. The transformed signal is compared with a threshold profile and a finite impulse response filter is configured to attenuate the amplitude of the audio signal being played by the loudspeakers only at such frequencies at which the target threshold is exceeded. The threshold may be derived from noise exposure limits published by regulatory authorities.

In an alternative scenario in which the hearer may have control over the sound heard, a particular risk can arise, mainly in the case of use of a wearable speaker device (whether an earphone or a pair of headphones) to listen to a desired audio signal the amplitude (i.e. volume) of which may be controllable by the listener, especially when there is significant ambient sound which might cause the listener to increase the amplitude of the desired audio signal. The desired audio signal can be of various kinds, for example from a source of music, e.g. an MP3 player, or from a caller to a call centre. Examples of this scenario are disclosed in EP-A-1,796,265; US-A-2007/195,970; US-A-20081025,525; US-A-2009/010,442 and US-A-2009/245,537.

EP-A-1,796,265 discloses a method of operating a media player including playing back audio media. During the step of playing back audio media, a maximum volume parameter is refined for the playing back of the media by the media player. The refining is based at least in part on the playing back of audio media during a time period prior to executing the maximum volume refining step. After a period of time, the maximum volume refining step is repeated. The refining is configured to prevent/minimize harm to hearing of the media player user based, for example, on the actual volume of media playback and time/duration profiles provided by occupational safety and/or other organisations.

US-A-2007/195,970 discloses a hearing protection method which includes the steps of: obtaining digital audio signals from a portable audio signal source; sampling the digital audio signals and obtaining a plurality of amplitude values; calculating an audio energy within a predetermined time period according to the amplitude values sampled in the predetermined time period; determining whether the audio energy reaches a predetermined value; and generating a hearing protect signal when the audio energy reaches the predetermined value, thereby protecting the user's hearing. A corresponding sound output device for hearing protection is also disclosed.

US-A-2008/025,525 discloses a method for controlling sound volume of an earphone. The method includes first detecting if a sensor in the earphone is triggered, and then a counter begins to count from the time when the sensor is triggered. The counting value of the counter represents an operating time of the earphone. The volume of the earphone is reduced when the operating time reaches a default value. Thereby, the purpose of protecting the user's hearing is achieved. The system includes the following features:—

1. LEQ Measurement: a technique that measures the average audio output levels. An external LEQ measurement arrangement may be used to determine LEQ vs. volume settings for particular music or players, or may be included in the player itself.

2. Cumulative tracker: totals up the time and volume at which the player is operated, and determines when the safe amount of total sound has been reached. It then takes the configured action-automatically limit the volume to a safe level and/or displays messages on a screen.

3. Timer: used to track running times of the player at the various levels, as well as rest time between sessions.

4. Visual Display Control: display of the volume output level of the system, as set by the user and/or as adjusted by the volume limiter. It also is used to display warning/alert messages. Such messages may be “Safe time & volume exceeded, volume has been reduced” or (if the automatic volume control is disabled) “Please reduce volume now to avoid hearing damage”.

In US-A-2009/010,442, a method for audio processing suitable for use with an earpiece is provided. Among various embodiments of noticeably different characters, one embodiment employs a “safe level checking” system which includes a system to monitor the total sound exposure of the listener (SPL_Dose measurement system). The safe level checking system can receive input audio from either an audio interface, ambient sound from an ambient sound microphone [ASM], internal sound within the ear canal via an ear canal microphone [ECM], or sound produced from an ear canal receiver [ECR] and captured by the ECM. The safe level checking system can control the reproduction level of an ECR signal when generating the output audio to reduce the chance of permanent hearing damage to the user. The safe level checking system can select compression curves and/or automatic gain coefficients to adjust the input audio to within safe listening output audio. The SPL_Dose measurement system keeps a record of the total sound exposure to the listener (measured or estimated at the ear drum). An SPL_Dose is calculated, that is a percentage value of the running personal exposure dose (i.e. the dose is not reset every day, but carries on when the earphones are worn), where 100% corresponds to a maximum daily dose (e.g. according to authoritative recommendations) and a value greater than 100% indicates that the user may be at risk of permanent hearing damage. The SPL_Dose value is communicated to the user by either or both visual means (e.g. a read-out of the dose on a display on a mobile communications device or Portable Media Player [PMP] screen) or auditory means (e.g. a voice message indicating the SPL_Dose, or a voice message or non-voice message indicating when the SPL_Dose is a particular value, e.g. 75% and 100%). In at least one exemplary embodiment, the SPL_Dose is converted to a time value indicating the total remaining time that the user can continue to listen to reproduced audio content at a given average SPL value (e.g. an SPL value approximately equal to the recent average SPL value generated by reproduced audio content). The user can be informed of this time value using visual and/or sound means, as with the SPL_Dose. In another embodiment, an operating mode is selected either manually using interface means (e.g. via a keypad entry on a PMP or mobile phone) or automatically, for instance with non-user changeable means depending on regional laws, to invoke a fixed maximum reproduction limit. This maximum limit may be a peak or root mean square [RMS] dB SPL value, approximating the SPL measured at the eardrum. When the “limiting mode” is selected (i.e. either automatically or manually) then an automatic gain control [AGC] that processes the input audio (e.g. the mix of audio content from a media player and audio from an ASM and/or ECM) is updated so that the maximum peak or RMS value of audio reproduced with the ECR is equal to the predetermined maximum limit value. In a further embodiment, when the limiting mode is not selected, the upper value of the AGC is set by the SPL_Dose system, e.g. to allow the user to listen to audio content at a predetermined level for a predetermined length of time to reduce the likelihood of permanent hearing damage.

US-A-2009/245,537 discloses a system having a program that takes the average db level of a music device after a certain amount of time and records at the same time the amount of time the user has been listening to the music device. The program then automatically adjusts the volume level so that the equivalent sound pressure related to the average decibel level [LEQ] would be at a safe level in relation to the amount of noise (music) to which the user has been exposed.

In the second scenario, commercially available systems for protecting against Noise Induced Hearing Loss [NIHL] are based upon calculations derived from sound intensity measured in Decibels and duration of exposure. The calculations do not take frequency into account. The human ear is particularly sensitive to frequencies in the range of 1 khz to 8 khz. This sensitivity may be caused by the shape of the human ear and/or simply how the brain works.

According to one aspect of the present invention, there is provided a method of warning and/or reduction of risk of ear damage of a hearer by excessive exposure to relatively high volume and/or frequency of sound, wherein a non-audio input representative of desired sound and/or ambient sound is employed to warn of said risk and/or said risk is automatically reduced.

According to another aspect of the present invention, there is provided a system for warning and/or reducing risk of ear damage of a hearer by excessive exposure to relatively high volume and/or frequency of sound, comprising means comprised of a data processor and arranged to receive a non-audio input representative of desired sound and/or ambient sound and to warn of said risk and/or automatically to reduce said risk.

Owing to the invention, it is possible to reduce the incidence of ear damage, which is becoming an increasing (and increasingly recognised) problem in modern times.

The invention can be applied in various scenarios. One is to protect a wearer of a speaker device, such as an earphone or a pair of headphones, against ear damage caused by excessive exposure to desired sound, such as music, from the speaker device. Another is to protect such wearer against the combined effect of that desired sound and ambient sound. A further is to protect a hearer against ambient sound alone, such as sound in a factory (which may often include sound from a loudspeaker) or sound on a building site. The sound may be excessive in respect of its volume and/or its frequency, since higher audio frequencies are more damaging to the human ear than lower audio frequencies. The exposure to the sound may be excessive in respect of its total time over a given period. Accordingly, the volume and/or frequency and time of exposure are recorded and available for retrieval.

In a preferred embodiment, an “iPhone”® or MP3 player “app.” (i.e. application) incorporates the following ear safety criteria.

| | Safe listening |
|---|---|
| Sound (e.g. music) | time totals |
| volume levels: | per 24 hrs. |
| 85 dB (decibels) | 8 hrs |
| 88 dB | 4 hrs |
| 91 dB | 2 hrs |
| 94 dB | 1 hr |
| 97 dB | 30 min |
| 100 dB | 15 min |
| 103 dB | 8 min |
| 106 dB | 4 min |
| 109 dB | 2 min |
| 111 dB | 1 min |
| 114 dB | 30 sec |
| 117 dB | 15 sec |
| 120 dB | 8 sec |
| 123 dB | 4 sec |
| 126 dB | 2 sec |
| 129 dB | 1 sec |

In the case of an Internet-and multimedia-enabled smartphone, such as an “iPhone”® telephone, the app. is used to measure an electrical input signal corresponding to the audio output of (an) earphone(s) connected to an “iPhone”® telephone. Whenever the above levels are exceeded, the electrical input signal should cut out. Additionally or alternatively, an alarm can be sounded 10 minutes, 5 minutes, 1 minute and 10 seconds, before the safe time total at, say, 100 dB, is exceeded. There could also be a visual message on and/or vibration of the “iPhone”® telephone.

The app. could work when there is no music being played, e.g. could warn about excessive ambient sound as well.

In respect of digital audio players, in particular an MP3 player, the volume control slider on the player should indicate the earphone levels in dB.

In respect of a portable media player in the form of an “iPod nano”® player, a study has shown the following safe time-weighted averages (TWA) for listening to the “iPod nano”® player at various volumes, which would again be incorporated into the app.:—

| Percent of | Equivalent | Time to Reach |
|---|---|---|
| Maximum | Volume | Safe Daily Dose |
| Volume | dB | (85 dB TWA) |
| <=40% | <=73 | Unlimited |
| 50% | 81 | 8 hours |
| 60% | 87 | 4.5 hours |
| 70% | 92 | 1.6 hours |
| 80% | 98 | 23 minutes |
| 90% | 106 | 4 minutes |
| 100% | 111 | 1 minute |

The dB levels on the app. can be displayed in colours, so, when the user sets the volume at say 87 dB, the dB numbers start turning from orange to red.

The app. advantageously detects the volume level of the earphones and compensates for when the user turns the level up or down. For example, if a user has been listening to earphones at 92 dBs for 1.5 hours he has 10 minutes left but, if he turns the volume down to 89 dB, he can listen for 20 minutes. The app. would tell him this. As a general rule; for every +3 dB, the safe listening time is halved and for every −3 dB the safe listening time is doubled.

The app. should remember the number of hours per day the user has been listening to music and the dB levels, even if the app. is switched off, and it should be able to show the user how long he has left according to safe listening times.

The user may need to be able to set his preferences for the safety features, e.g. he may want to override an automatic system or he may prefer to be warned when he has, say, 1 hour of ‘safe’ listening time left, or he may want to limit the earphones so they only put out safe levels; this could optionally be passworded so that parents can set safe levels for their children.

Advanced user preferences could allow users to choose what happens when the safety levels have been exceeded, e.g. they can choose that the music automatically turns down to a safe level, or that they receive a warning alarm, vibration, or message alert or a combination of any of them.

The app. could also have a ‘stats’ page that keeps count of how long and at what level the user listens to music each day, perhaps keeping a record for, say, the last week.

The app. may include a list of text messages which would pop up when a user hits a link or when an ambient sound microphone has picked up a loud sound; for example, a message could read ‘87 dBs—you can listen with your headphones at this level for 4.5. Hours’.

If the user exceeds the recommended level or listening time for safe hearing on any day, a message may appear on the device screen; other possible means of sending a user alert include an audio alert, for example an audio message (via an earphone or headphones), or vibration.

Advantageously, the app. may take into account not only the volume of the sound to which the ear may be exposed but also the frequency of that sound, so that warning and/or the reduction of risk is produced as a function of the total time period, the sound volumes and the sound frequencies.

In order that the invention may be clearly and completely disclosed, reference will now be made, by way of example, to the accompanying drawings, in which:—

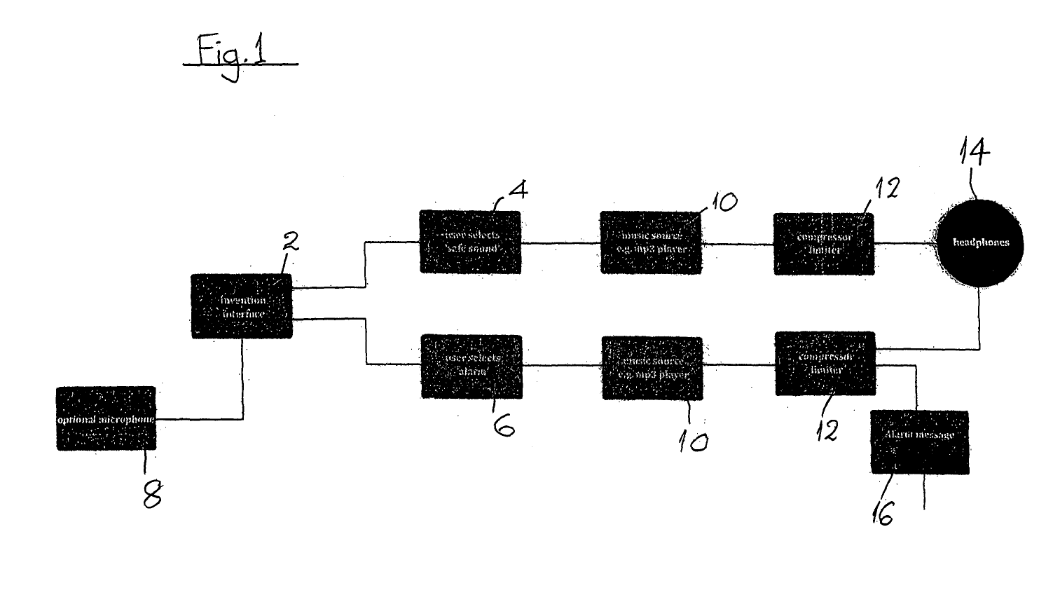

FIG. 1 is a diagram of steps in a method of warning and/or reduction of risk of human ear damage;

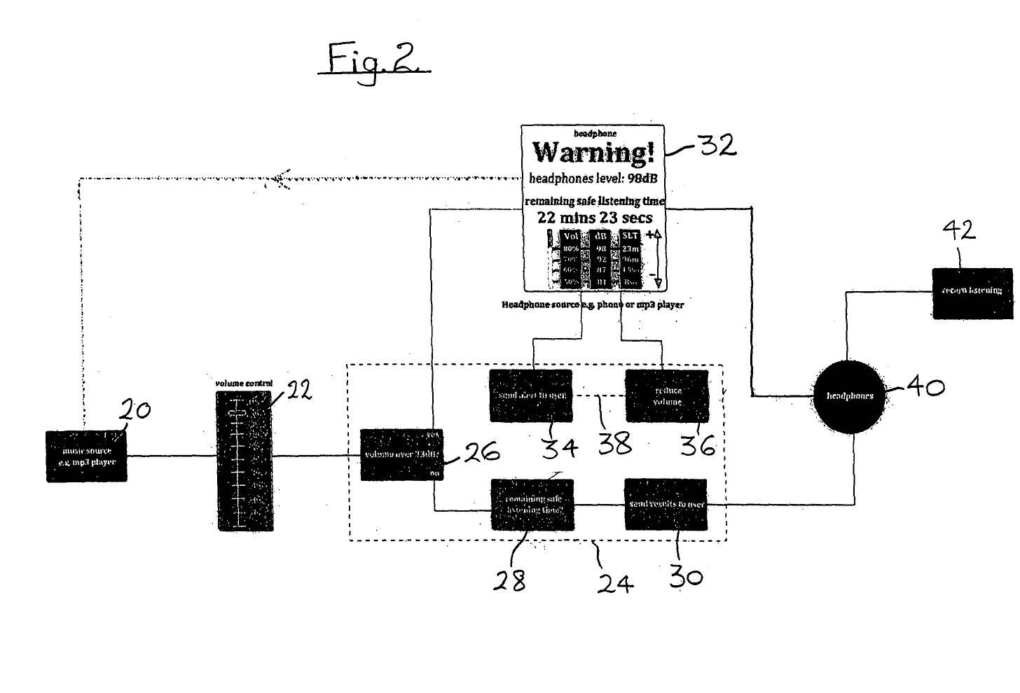

FIG. 2 is a diagram of steps in a modified version of the method;

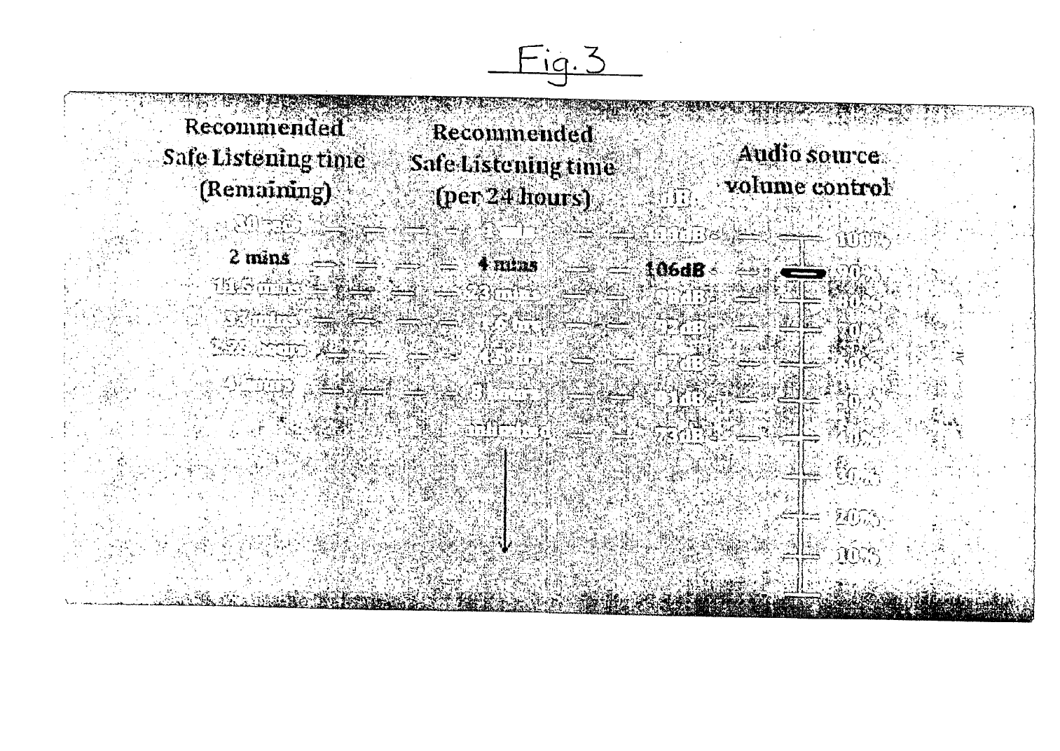

FIG. 3 is a diagram of a table displayable on a screen of a telephone (in particular an Internet—and multimedia—enabled smartphone (e.g. an “iPhone”®) or digital audio player (preferably an MP3 player);

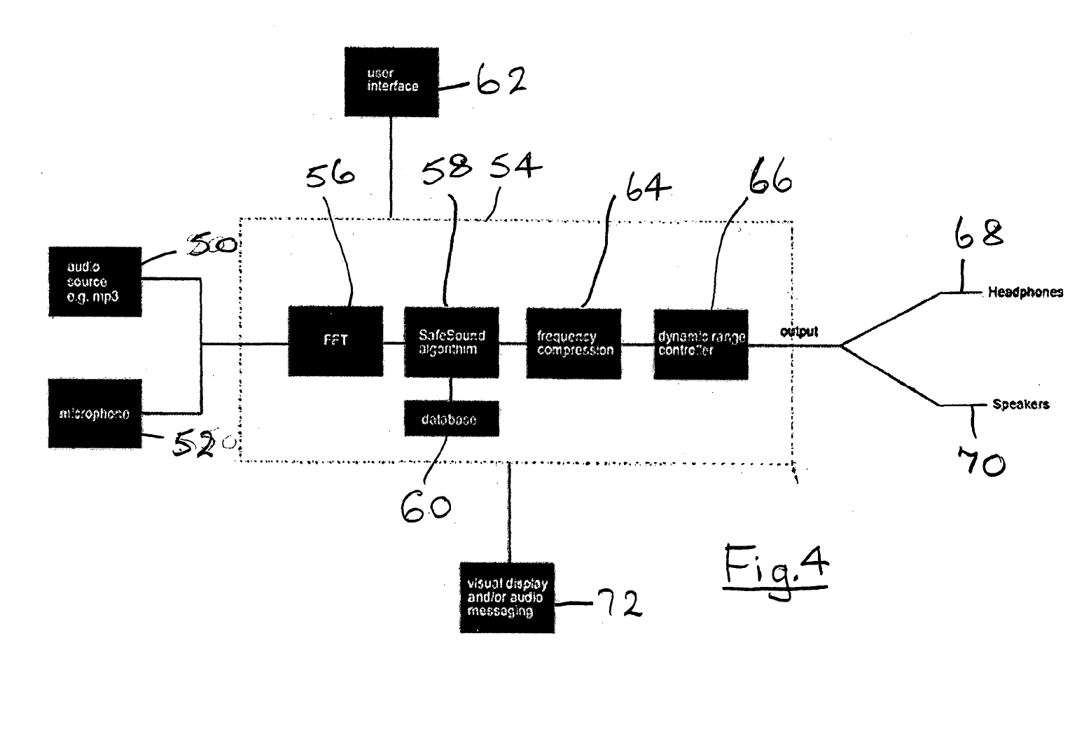

FIG. 4 is a diagram of steps in another modified version of the method;

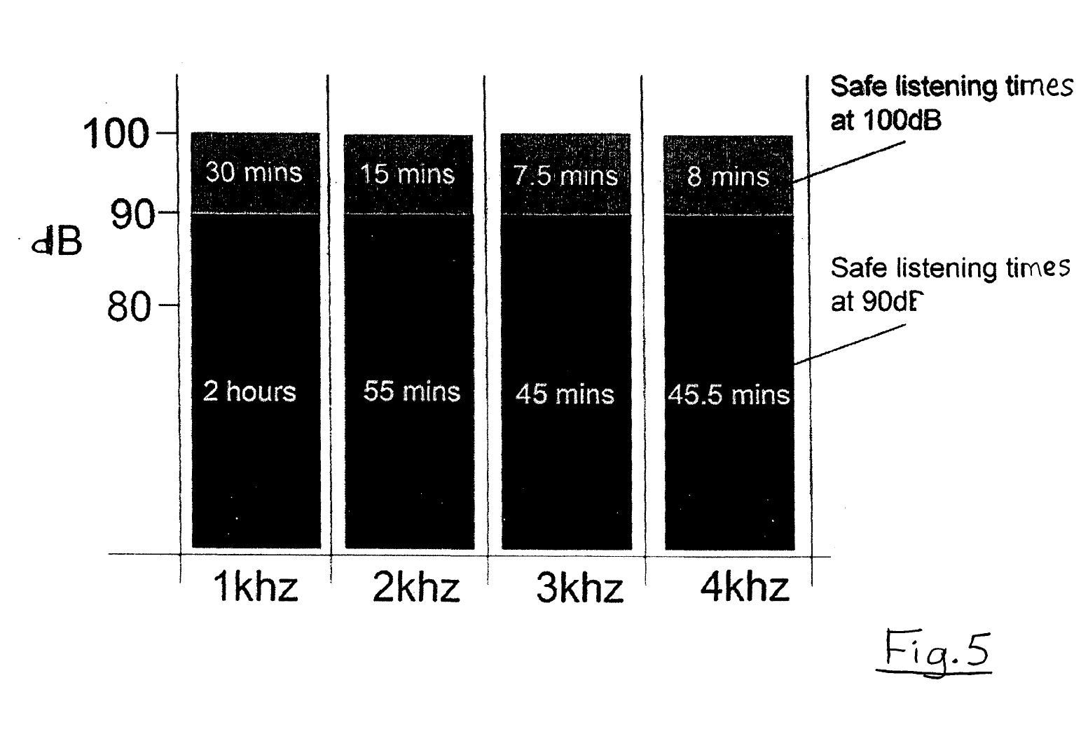

FIG. 5 is a diagram illustrating safe listening times for individual frequencies;

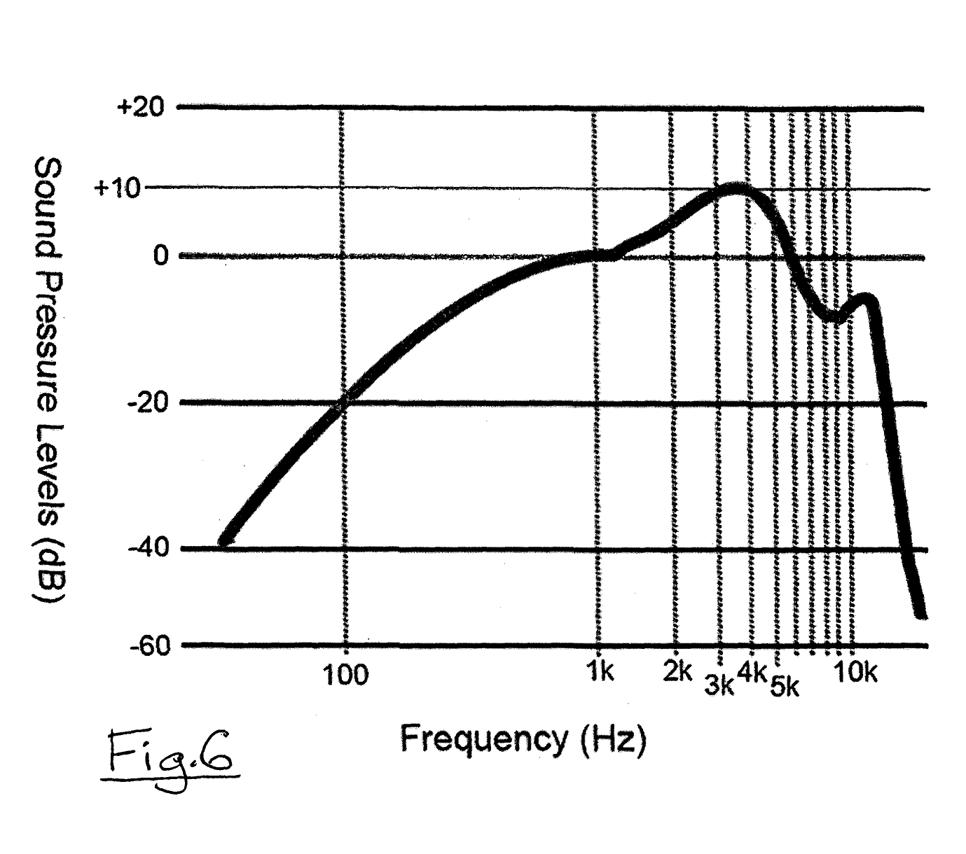

FIG. 6 is a graph of in-ear sound pressure levels in dB against frequency in Hz and illustrates the difference in loudness of different frequencies as perceived by the human ear, using the in-ear sound pressure level at 1 kHz as an arbitrary zero reference; and

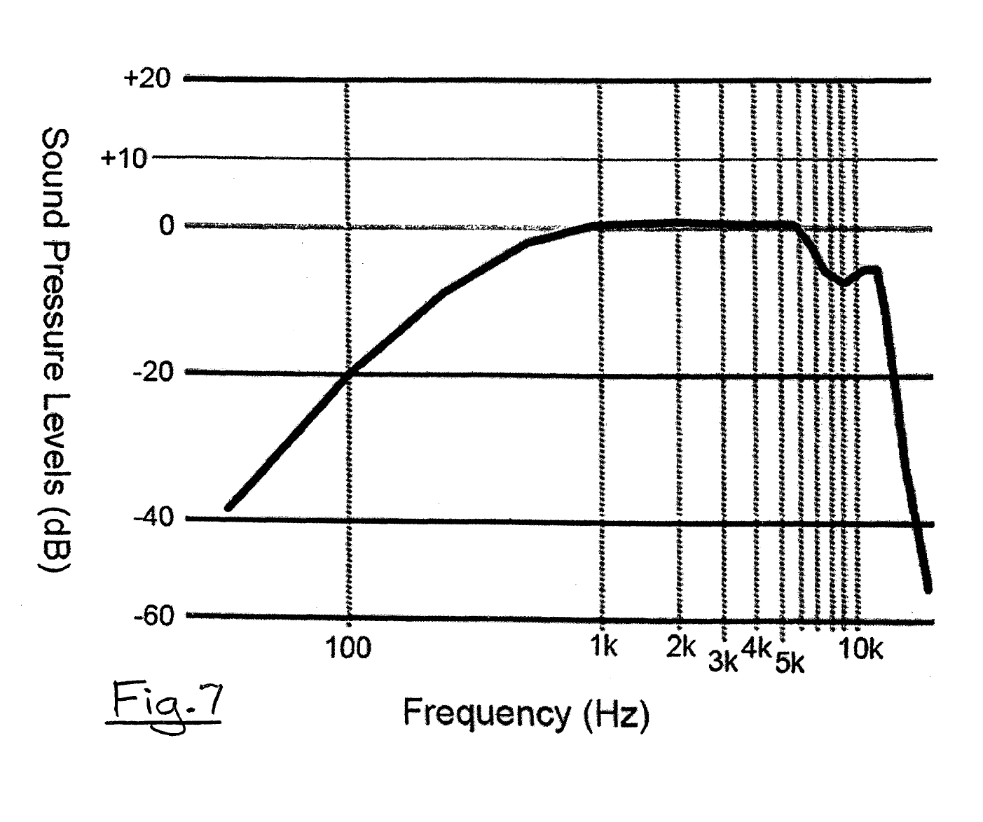

FIG. 7 is a graph corresponding to that of FIG. 6, but showing an effect achievable with the method of FIG. 4.

Referring to FIG. 1, in the method schematically illustrated therein an interface 2 between a listener and an app. constituting an embodiment of the present invention enables the user to select one or both of a “safe sound” option 4 and an “alarm” (i.e. warning) option 6. In addition, or alternatively, the user can select, at the interface 2, an optional microphone 8 which picks up ambient sound. The interface 2 may include a software display from which the various options may be selected. The user may then select a musical composition from a music source 10, e.g. an MP3 player, (shown in duplicate for ease of illustration). By means of a compressor/limiter 12 (again shown in duplicate for ease of illustration) the user can set, or have set for him, the maximum desirable exposure to sound. If the user has selected “safe sound”, the maximum sound volume, and/or the maximum sound exposure of the listener as a function of sound volume and time period of exposure to sound, at headphones 14, in this example, is not exceeded, unless the compressor/limiter 12 is overridden. If the user selects “alarm” 6, then, if either of the above maxima is attained, an alarm message 16 is emitted.

In the version shown in FIG. 2, the user can again select a musical composition at the music source 20, e.g. an MP3 player. The user sets the volume control 22 at, in this instance, 90%. A “safe sound” app. 24 determines (26) whether the output of the music source 20 would produce a volume over the conventionally accepted “safe” volume of 73 dB. If the volume is not over 73 dB, the app. 24 calculates the remaining safe listening time (28) and sends the results to the user (30). This may be done by means of the display and data processing device 32 which would be part of the media player 20 (or of a smartphone). The display 32 is illustrated separately from the music source 20 for ease of illustration. If the determination 26 is that the output volume of the MP3 player is over 73 dB, then that information is communicated to the display and data processing device 32 which calculates and displays the remaining SLT (safe listening time). If the device 32 deems that the user should be warned, an alert is sent to the user, as indicated at 34. The user can then reduce the volume, as indicated at 36 or, if so desired, following sending of an alert to the user (34), the volume can be automatically reduced as indicated at 38. If the volume is reduced, then the initial input to the headphones 40 is of course reduced accordingly. If desired, the noise exposure can be recorded in a recording device, as indicated at 42.

Referring to FIG. 3, assuming that the volume control 22 is set as illustrated in FIG. 2, the app. table according to FIG. 3 gives the maximum safe listening time per day at that volume level and the remaining safe listening time per day at that level. The table which would appear for a volume control set at 80% appears in FIG. 2.

In a particularly preferred embodiment of the invention, an earphone or headphone safety device warns the wearer when he has been listening to audio at damaging frequencies and volumes for a time period, or an accumulation of time periods, such that he is approaching risk of hearing damage, and/or warns the wearer when his ears need a break to avoid permanent hearing loss.

The particularly preferred embodiment can be utilised in the following ways:—
(1) with visual and vibratory alarms when risky sound levels are exceeded (on both ambient sound and digital audio player sound) and possibly with spoken warning.
(2) the wearer has the option to select ‘safe sound’ mode, when desired sound, e.g. music, will automatically be cut out or be lowered (as set by the wearer in preferences in the app.) when safe hearing levels have been exceeded or even existed for prolonged periods,
(3) the loudness and frequencies of ambient noise are displayed in decibels and kilohertz, so that the device can be used as a ‘noise meter’, e.g. to analyse the sound of hifi (high fidelity), tv (television), traffic, or office noise.

That embodiment may include a visual ‘rolling screensaver’ based on colour representation of ambient sound and/or digital audio player sound, or both, e.g.
blue for sound under 1 khz frequency and less than 3 dB, and green for over 3 dB,
yellow for sound between 1 and 5 khz, and under 3 dB, and orange for above 3 dB,
red for sound between 6 and 12 khz and under 3 dB, and white for over 3 dB.

In the version shown in FIG. 4, the user can again select a musical composition at a music source 50, e.g. an MP3 player, and/or ambient sound can be picked up by a microphone 52. A “Safe Sound” app.54 utilises a Fast Fourier Transform FFT algorithm 56 to provide a frequency spectrum of audio input to a “Safe Sound” algorithm 58 which identifies potentially harmful frequencies and reduces their intensity (amplitude) on a one-by-one basis, so that frequencies remain within safe listening limits as preset from a database 60 or as chosen by a user at an interface 62. Frequency compression 64 is utilised for that purpose, whilst a dynamic range controller 66 determines the volume output to headphones 68, or to one or more speakers 70 in, e.g., a room or a hall. The user can be kept informed by visual display and/or audio messaging 72.

As will be understood from FIG. 6, potentially damaging sound pressure levels in the inner ear can occur for a given sound in air external of the middle ear. However, for that same sound, as illustrated in FIG. 7 the method of FIG. 4 can cause the inner ear sound air pressure levels over the 1 to 5 kHz range to be maintained below potentially damaging levels.

The method disclosed in FIG. 4 uses the algorithm 58 to assess the true potential that sound has for causing NIHL by analysing each frequency (or key frequencies) present in sound being listened to live (such as at a concert) or recorded (such as from speakers or headphones).

The frequency compression 64 is utilized to reduce the intensity (amplitude) of potentially harmful frequencies on a ‘one-by-one basis’ and is implemented by applying a negative gain (as shown in FIG. 7) to selected spectrum components in an audio recording.

As an example, a piccolo has a frequency range of approximately 2 to 4 khz. At 4 khz a typical A-weighted sound meter (Dosimeter) may register a sound pressure level (SPL) of 90 dB but, owing to the shape of the outer and middle ear, 4 khz at 90 dB could be amplified to 102 dB as perceived by the ear. The difference is significant; the recommended safe listening time at 90 dB is just under 2 hours, whereas the recommended safe listening time at 102 dB is just 8 minutes. If a user were to choose to listen to music at 90 dB and that music contained a piccolo playing at 4 khz, the method of FIG. 4 could reduce the amplitude at that frequency by 12 dB without affecting other frequencies, meaning that the user would actually remain within true safe listening limits. In other words, the 4 khz frequency would be reduced (limited) to 78 dB (maximum) in order for it to seem as loud as other frequencies the maximum dB value of which could be 90 dB. The user would barely notice the difference. Furthermore, this method allows users to listen to music for longer without damaging their hearing.

The method of FIG. 4 uses the information gained from the FFT 56 to calculate true safe listening limits and remaining safe listening time by keeping a running analysis of both audio frequency and amplitude exposure. This data for a period of time may be saved in the database 60 and retrieved for further analysis.

The dynamic range controller 66 allows the user to select and remain within a desired safe listening time as a function of frequency and amplitude.

There are collected and stored in the database 60 (which could be external, rather than internal, of the app.54) key listening statistics such as length of time sound was listened to, its frequency content, and its intensity (loudness). The method uses this key data to create, if desired, a report that can be customised by the user. The report can be produced regularly, say daily, weekly, or monthly, and e-mailed to users or others.

The formulae of the algorithm 58 employ:—
Overall Sound intensity (dB)
For each frequency, magnitude of intensity (dB)
Safe listening time limits for each frequency (as determined by health organisations, audiologists etc.) measured in minutes and seconds

For example, overall safe listening time if a headphone user listens to music at in-ear 90 db is 2 hours. For music at a constant frequency of 4 khz at measured 91 db for one minute, the algorithm 58 calculates as follows:—

4 khz×1 minute at measured 91 dB (=103 in-ear dB)=24 minutes at in-ear 91 dB, therefore the safe listening time is reduced accordingly, i.e. 1 hr 36 minutes safe listening remains at measured 91 dB. In practice the algorithm 58 calculates the safe listening time consumed over a spectrum of frequencies.

### The Algorithm 58 Uses:

1. Preset, or user-chosen, overall earphone or headphone desired sound intensity (dB) to work out guide safe listening times based upon guide criteria stored in the database 60.
2. Individual frequency intensity (dB) as received from the FFT 56 to work out true safe listening time.
3. Calculates the attenuation (if any) required for the amplitude of each frequency.

Whenever a measured frequency is detected above 85 dB a record is created detailing its intensity and time listened to.

When the safe listening time for, say, frequency X is reached or nearly reached, the user is warned and given the options to continue listening, stop listening, or to lower the amplitude of frequency X, to avoid potential hearing loss.

The method of FIG. 4 keeps a running analysis of all measured frequencies within the audio input spectrum, their amplitudes, and durations listened to. It can employ user-set profiles to decide the safe listening time for each frequency, or a company preset profile that uses government health or specialist hearing data that specifies safe listening times.

Although primarily designed for earphone or headphone users of mobile devices, e.g. iPod® and iPhone®, the present method can also be installed in professional and domestic hifi's with speakers. Moreover, it may be installed on a laptop or desktop personal computer [PC] connected to any number of microphones from 1 upwards and used to analyse ambient sound, sound in workplaces, or in concert halls or theatres, for example.

The present system can be used as a personal hearing manager (PHM) that monitors, analyses, reports on and optionally polices, all audio of one or more hearers.

It can be used to report unobtrusively on:
the listening habits of earphone or headphone users, such as children
sound exposure in the workplace (e.g. building sites, restaurants, and recording studios)
sound exposure in everyday places (e.g. home, street, clubs and concert halls.)

It can also be used as a safety tool that measures and reports on any harmful content of audio emitted by machinery, or speakers in car systems.

The present method can be used to control an electronic earplug that can raise or lower noise isolation to provide audio safety in noisy environments such as shooting ranges or building sites.

The present method uses three criteria to measure and assess harmful sound exposure:
A) dB volume, namely dB volume of overall audio and dB volume of individual frequencies;
B) listening duration, namely listening duration of overall audio, and listening duration of individual frequencies; and
C) frequency content, namely frequency (e.g. 20 hz to 20 khz), sound amplitude at particular frequency, and frequency potential for causing hearing damage as revealed by research (e.g. higher frequencies=higher potential for damage).

Particular advantages of embodiments of the present method and system will be clear from the following illustrative examples:—

### EXAMPLE 1

A musician can use the system to analyse the sound of his instrument, e.g. saxophone, drums or violin. He will be informed of the dominant frequencies and the associated safe listening time for each, according to its amplitude. He has the option of setting a safe listening time for rehearsing or performing. The system will inform him when the end of safe listening time approaches and/or has been exceeded, for example by playing an audible warning, via headphones or a speaker on the host device e.g. iPhone®. The musician can also receive a written report in a desired format, e.g. email, detailing the duration of frequencies and amplitude exposure per day, per week, per month, for example, allowing him to keep a running record of sound exposure.

### EXAMPLE 2

A layman, e.g. factory floor worker, can use the system to analyse the ambient noise in his environment to indicate the dominant frequencies and their amplitudes.

The layman may then use the system to set accordingly a safe listening time alarm.

The system can inform him when the end of safe listening time approaches or play an audible warning, via headphones or a speaker on the host device e.g. iPhone®, thus allowing him to use ear protection or to leave the vicinity. He could use the system to inform him when he is at a safe distance away from dangerous noise emissions.

He also can receive a similar written report in a desired format allowing him to keep a running record of sound exposure, which allows him to comply with, rules & regulations governing health and safety at work.

### EXAMPLE 3

A user may use the system to analyse the music he listens to on headphones or earphone. When the system is activated it places the processed audio in a buffer for analysis prior to playing in the user's headphones or earphone.

The system can analyse pre-recorded music formats, e.g. MP3, and draw a wave form for each recording that can be used to extract information such as frequency content and corresponding amplitudes.

The system will display the dominant frequencies and the associated safe listening time for each, individually and as a sum, according to the amplitude.

The user may optionally choose to allow the system to treat any potentially harmful frequencies (e.g. 2-4 kHz) to protect against NIHL and so lengthen the safe listening time.

The system can also lower his headphone output or shut it down when safe listening times have been reached. This function can be enabled and disabled by a security password, thus allowing parents to govern children's listening habits and to protect them from NIHL.

The system can inform the user via an interface on his music player (iPod®, laptop, iPhone®, etc.) when the end of safe listening time approaches or has passed, for example, by playing an audible warning, via headphones or a speaker on the host device.

The user or another person can also receive a similar written report in a desired format allowing him to keep a running record of sound exposure.

### EXAMPLE 4

Modern disc jockeys (DJs) use laptops or desktop computers to mix and play music at parties and clubs and other venues.

The system can be installed on their computers as a stand-alone application or incorporated in their regular music playing/mixing software.

The system can be calibrated to music amplifiers so it ‘knows’ the dB output of amplified sound emitted from speakers connected to the system.

Vital statistics such as frequency content, corresponding amplitudes, and duration of playing time are recorded and available for viewing and further analysis by the DJ and/or venue proprietors, allowing them to comply with health and safety limits.

A DJ or venue proprietor can choose one or more settings on the system, or custom preset the system, to limit potentially harmful frequency content and comply with health and safety rules and regulations.

Limiting or attenuating of harmful frequencies by the system allows the DJ to extend safe listening times.

The system can limit or cease the output of amplified music once safe listening time limits have been reached.

The system can set a safe listening time based on how loud the music is played or for how long it's played, e.g. if a DJ selects 4 hours the system will determine the upper limits for how loud the music can be played.

The DJ and/or the venue proprietor can also receive a similar written report in a desired format, allowing him to keep a running record of sound exposure. This allows the DJ and the proprietor to comply with rules & regulations governing health and safety at work and in public places.

1. A method of warning and/or reduction of risk of ear damage of a hearer by excessive exposure to relatively high volume and/or frequency of sound, wherein a non-audio input representative of desired sound and/or ambient sound is employed to warn of said risk and/or said risk is automatically reduced.

2. A method according to claim 1, wherein potentially harmful frequencies of said non-audio input are identified and reduced in intensity.

3. A method according to claim 1 or 2, wherein said non-audio input is fed to a calculating device worn by said hearer and connected to a warning device for provided said warning.

4. A method according to any preceding claim, wherein said desired sound is emitted by a speaker device worn by said hearer.

5. A method according to any preceding claim, wherein the warning is by colour change.

6. A method according to any preceding claim, wherein the warning is by a plurality of warnings emitted at intervals.

7. A method according to claim 6, wherein said warnings are emitted at decreasing intervals.

8. A method according to any preceding claim, wherein the warning and/or the automatic reduction of said risk comprises warning of and/or preventing the volume and/or frequency of said desired sound and/or said ambient sound as heard by said hearer exceeding a maximum or maxima.

9. A method according to any preceding claim, wherein the warning and/or the automatic reduction of said risk comprises warning of and/or preventing said excessive exposure as a function of volume and/or frequency and length of hearing time of said desired sound and/or said ambient sound heard by said hearer exceeding a desired maximum or desired maxima.

10. A method according to any preceding claim, wherein said risk is automatically reduced, but the automatic reduction can be overridden.

11. A method according to claim 10, wherein a password is required to override the automatic reduction.

12. A method according to any preceding claim, wherein the hearer's exposure to said desired sound and/or said ambient sound within an overall period is recorded so as to be accessible.

13. A method according to any preceding claim, wherein the automatic reduction is performed in an electronic earplug.

14. A system for warning and/or reducing risk of ear damage of a hearer by excessive exposure to relatively high volume and/or frequency of sound, comprising an arrangement comprised of a data processor and serving to receive a non-audio input representative of desired sound and/or ambient sound and to warn of said risk and/or automatically to reduce said risk.

15. A system according to claim 14, wherein an FFT is employed in identifying potentially harmful frequencies and frequency compression is employed to reduce the intensity of those frequencies.

16. A system according to claim 14 or 15, wherein a calculating device intended to be worn by said hearer is arranged to receive said non-audio input and is connected to a warning device for providing said warning.

17. A system according to claim 16, wherein said warning device is arranged to warn by audio.

18. A system according to claim 16, wherein said warning device is arranged to warn by colour change.

19. A system according to any one of claims 14 to 18 and including a speaker device arranged to emit said desired sound and intended to be worn by said hearer.

20. A system according to any one of claims 14 to 19, wherein said arrangement comprises an overriding device whereby the automatic reduction can be overridden.

21. A system according to any one of claims 14 to 20, wherein said arrangement includes a recording device whereby said hearer's exposure to said desired sound and/or said ambient sound within an overall period is recorded and is accessible.

22. A system according to claim 14 or 15 and in an electronic earplug, said arrangement serving automatically to reduce said risk.
